(19) United States
(12) Patent Application Publication
(10) Pub. No.: US 2007/0109324 A1
(43) Pub. Date: May 17, 2007

(54) Interactive viewing of video

(76) Inventor: Qian Lin, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/280,062

(22) Filed: Nov. 16, 2005

(51) Int. Cl. G09G 5/00

(52) U.S. Cl. 345/671

(57) ABSTRACT

Interactively displaying video includes outputting the video for playback at full resolution, receiving an externally-generated command to enlarge an area of the video while the video is being played, upscaling the area, and outputting the upscaled area for display.

### BACKGROUND

Videos on DVDs and VHS cassettes can be viewed interactively, but the options for interactive viewing are somewhat limited. Typically, a viewer can start, stop, pause, fast-forward, and rewind a video.

Digital video recorders and media center computers allow live television feeds to be viewed interactively, but here too, the options for interactive viewing are somewhat limited. Typically, a viewer can pause a live television feed. When a viewer pauses a live feed, the digital video recorder or media center computer stores video to a hard drive. When play is resumed, the video is played from the hard drive.

Interactivity can enhance the viewing experience. Additional interactivity that enhances the viewing experience would be desirable.

### SUMMARY

According to one aspect of the present invention, interactively displaying video includes outputting the video for playback at full resolution, receiving an externally-generated command to enlarge an area of the video while the video is being played at full resolution, upscaling the area, and outputting the upscaled area for playback.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIGS. 1a and 1b are illustrations of a system in accordance with an embodiment of the present invention.

FIG. 2 is an illustration of a method in accordance with an embodiment of the present invention.

FIGS. 3a-3d are illustrations of methods of identifying an area of interest in a video in accordance with embodiments of the present invention.

FIGS. 4a-4d are illustrations of methods of enlarging an area of interest in a video in accordance with embodiments of the present invention.

FIG. 5 is an illustration of a remote control unit in accordance with an embodiment of the present invention.

FIG. 6 is an illustration of a pan operation in accordance with an embodiment of the present invention.

### DETAILED DESCRIPTION

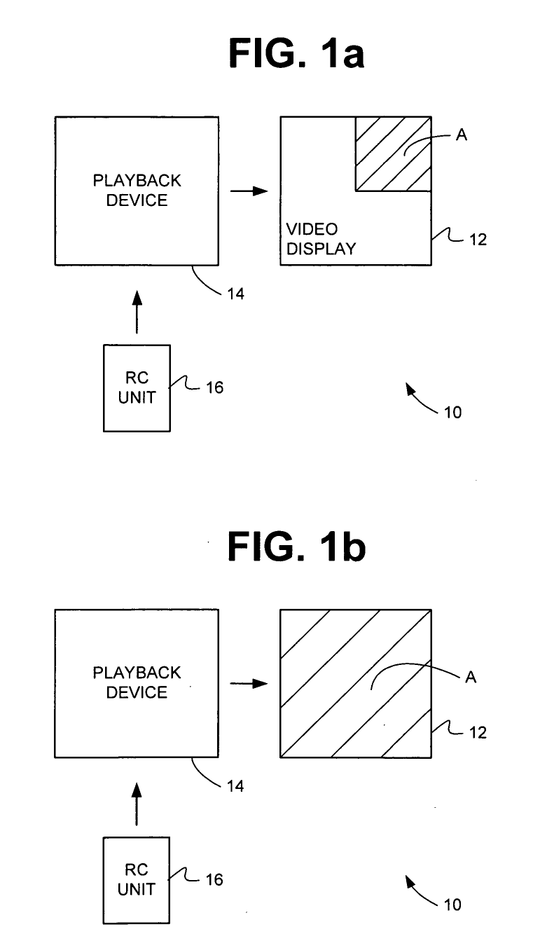

Reference is made to FIG. 1a, which illustrates a system 10 for interactively viewing video. The source of the video is not limited to any particular type. Exemplary video sources include, without limitation, DVDs, cable, and satellite. Typically, the video is provided as a bit stream that is compressed according to a standard such as MPEG. As explained below, high definition (HD) video is preferred over standard definition (SD) video.

The system 10 includes a video display 12, a playback device 14, and a remote control unit 16. The video display 12 is not limited to any particular type. For example, the video display 12 could be a television or computer monitor.

The playback device 14 can be a media center computer, a digital video recorder (DVR), a cable decoder box, a DVD player, etc. The functions performed by the playback device 14 can be implemented in hardware, firmware, software, or a combination.

The video display 12 could be integrated with the playback device 14. A digital television is an example of such a playback device 14.

The remote control unit 16 is used to control the playback device 14. The remote control unit 16 may offer standard features, which depend upon the type of playback device 14. For a playback device 14 such as a DVD player, the remote control unit 16 may offer standard features such as pausing, starting, reversing, and forwarding video. For a playback device 14 such as a cable decoder box, the remote control unit 16 may offer standard features such as a channel guide and channel selector. These features can also be called via a user interface (e.g., buttons) on the playback device 14.

The remote control unit 16 also offers a feature for enlarging an “area of interest” (A) in the video. While the video is being displayed at full resolution, the viewer uses the remote control unit 16 to select the area of interest (A). The playback device 14 enlarges the area of interest A, and the video display 12 displays the enlarged area of interest. The enlarged area of interest could be displayed in place of the full-resolution video (as shown in FIG. 1b), it could be displayed as a picture-in-picture (PIP), which is overlayed on the full resolution video, etc. This enlargement feature allows a viewer to see the area of interest in greater detail. For instance, a viewer could see a close-up of an actor by enlarging the area encompassing the actor.

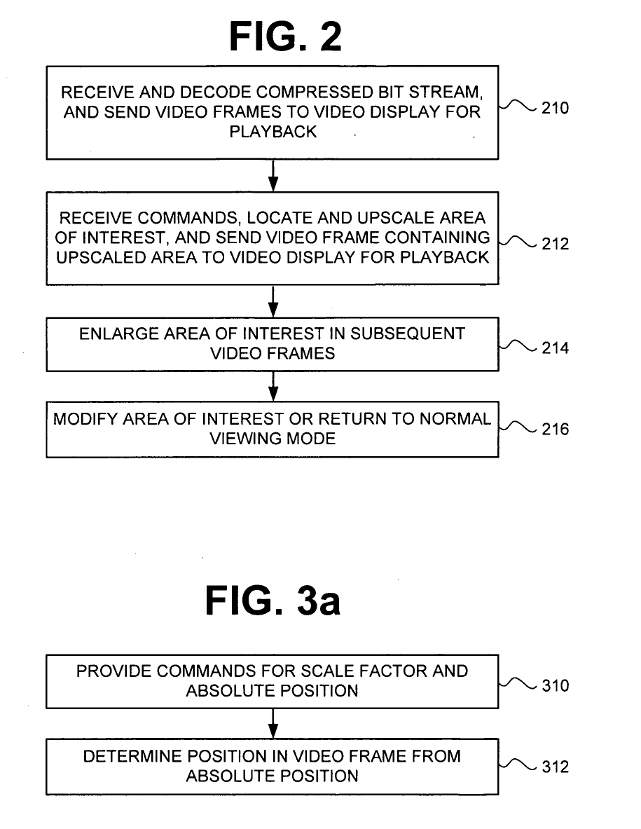

Additional reference is made to FIG. 2, which provides an example of how a viewer can use this area enlargement feature. At block 210, the system is operating in normal viewing mode: the decoder 14 is receiving a compressed bit stream from the video source, decoding the bit stream into video frames, and sending the video frames to the video display 12 for playback at a specific frame rate. In normal viewing mode, the video frames are displayed at full resolution at a nominal (e.g., 30 fps) frame rate.

At block 212, the viewer, while watching the video, uses the remote control unit 16 to enlarge an area of interest in the video. The remote control unit 16 generates a command, and transmits the command to the playback device 14. The playback device 14 receives this externally-generated command, locates and upscales the area of interest, and sends the upscaled area of interest to the video display 12.

The command could specify any of the following: scale factor, absolute center of the area of interest, and a motion vector. The content of the command will depend upon the type of remote control unit 16. One type of remote control unit 16 could specify a scale factor and a location on the display. For example the remote control unit 16 could have presets for zooming in on the center of a video frame, the upper left quadrant, lower right quadrant, etc. The playback device 14 would upscale the area about the specified location. In the alternative, the remote control unit 16 could command the playback device 14 to find an area of saliency in the video and zoom in on that area.

Another type of remote control unit 16 could generate commands to zoom to a current location in the video and then pan across a scene from the current location to the area of interest, or it could generate commands to pan to the area of interest and then zoom in on the area of interest. To command the panning from the current location to the area of interest, the viewer can simply move the remote control unit 16 in the direction of current location to the area of interest. The remote control unit 16 detects the motion, generates a motion vector indicating the motion, and sends the motion vector to the playback device 14. The playback device 14 uses the motion vector to update the current location.

Post-processing can be performed on the decoded bit stream, prior to upscaling. The post processing may include, without limitation, compression and artifact reduction.

The playback device 14 sends a video frame containing the upscaled area to the display device 14. The upscaled area can fill an entire video frame, or it can fill a picture-in-picture, etc.

At block 214, the playback device 14 enlarges the area of interest in subsequent video frames. The same spatial location in each subsequent frame of the bit stream is enlarged, until a new motion vector is generated, or the enlargement feature is turned off.

At block 216, the viewer can use the remote control unit 16 to zoom in further, zoom out, move to a new area of interest, and return to normal viewing mode. The viewer can also use the remote control unit 16 to select any of the standard features.

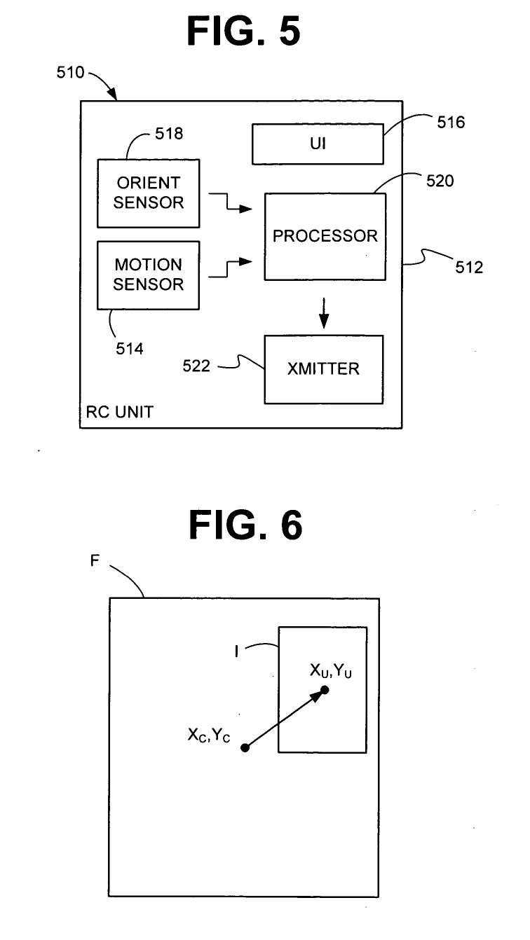

FIG. 6 illustrates an example of a pan operation. The current location in a video frame (F) is at coordinates x_{c},y_{c}, a motion vector (Δx, Δy) is represented by the arrow, the center location of the area of interest is at coordinates xᵤ,yᵤand the boundary of the area of interest is denoted by reference letter 1. Thus, the area about the current location (x_{c},y_{c}) is enlarged. As the remote control unit 16 is moved toward the area of interest 1, it generates a motion vector, and sends the motion vector (as part of a command) to the playback device 14. The playback device 14 uses the motion vector to compute the new location(xᵤ=x_{c}+Δx, yᵤ=y_{c}+Δy), enlarges the area about location xᵤ,yᵤ, and sends the enlarged area to the video display 12 The same spatial location is enlarged in subsequent video frames, unless a new motion vector is generated, or the enlargement feature is turned off.

Thus, the system 10 allows a viewer to get real-time closes-ups of different areas of a video. This additional interactivity can make a viewing experience more enjoyable. It can also increase the number of times a movie is viewed, since each viewing can be a unique experience (the viewer can focus on different aspects during each viewing).

Unlike surveillance systems, which pan and zoom in real time by controlling a camera or other video source, the system 10 enlarges an area in real time by decoding a bit stream into frames, and upscaling areas in the frames.

HD video is preferred. Many people cannot differentiate a movie shown at high definition or standard definition. In a sense, the additional information within the high definition content is wasted. The system 10 uses the additional information to enlarge the area of interest. Thus, the system 10 provides an incentive to consumers to purchase movies at high definition.

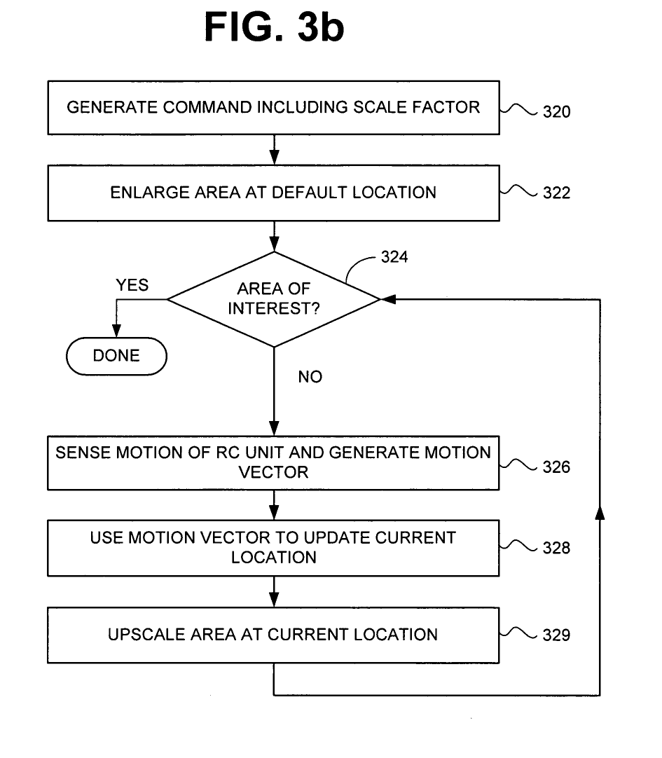

FIGS. 3a-3d illustrate different methods of identifying an area of interest in a video. Reference is made to FIG. 3a, which shows a first method. At block 310, the remote control unit 16 provides commands for scale factor and an absolute position on the video display 12. The absolute position may be selected from a group of presets. For example, the presets can correspond to the center of the display, the upper left quadrant, lower right quadrant, etc. At block 312, the playback device 14 receives the preset and determines the actual location in a video frame.

Reference is made to FIG. 3b, which shows a second method. The remote control unit 16 is used to zoom to a location in a scene and pan across the scene to the area of interest. At block 320, the remote control unit 16 generates a zoom command including a scale factor and sends the command to the playback device 14. At block 322, the playback device 14 receives the command to zoom and goes to a default location in the video frame or bit stream (e.g., the default location might be the center of the frame), upscales the area about the default location, and sends the upscaled area to the video display 12.

If the displayed area is not of interest, the viewer motions the remote control unit 16 toward the area of interest (block 324). At block 326, the remote control unit 16 senses the motion and generates a motion vector, and then sends a command including the motion vector to the playback device 14. At block 328, the playback device 14 uses the motion vector to recompute a new location in the bit stream or video frame (for example, by adding the motion vector to the current or default location). At block 329, the playback device 14 then upscales the area surrounding the new location, sends the upscaled area to the video display 12, and returns control to block 324. If the current location is at the area of interest, no further motion vectors will be generated.

Reference is now made to FIG. 3c, which shows a third method of identifying the area of interest. At block 330, the playback device 14 receives motion vectors from the remote control unit 16 and, in response, pans to the area of interest. During panning, the current location may be displayed on the video display. For example, the current location could be surrounded by a box that is filled with black color. Once the area of interest is highlighted, the remote control unit is used to generate a command that zooms in on the area of interest (block 332).

Reference is made to FIG. 3d, which shows a fourth method of identifying the area of interest. At block 340, the playback device 14 decodes a video frame, and identifies a saliency part of the video frame. The saliency part of a video frame can be computed by analyzing color, intensity contrast, and local orientation information in the frame. See, for example, a paper by L. Itti and C. Koch, and E. Niebur entitled “A model of saliency-based visual attention for rapid scene analysis” in Pattern Analysis and Machine Intelligence, IEEE Transactions on Volume 20, Issue 11, November 1998 pp. 1254-1259. After the saliency part has been identified, the playback device 14 zooms in on the saliency part (block 342).

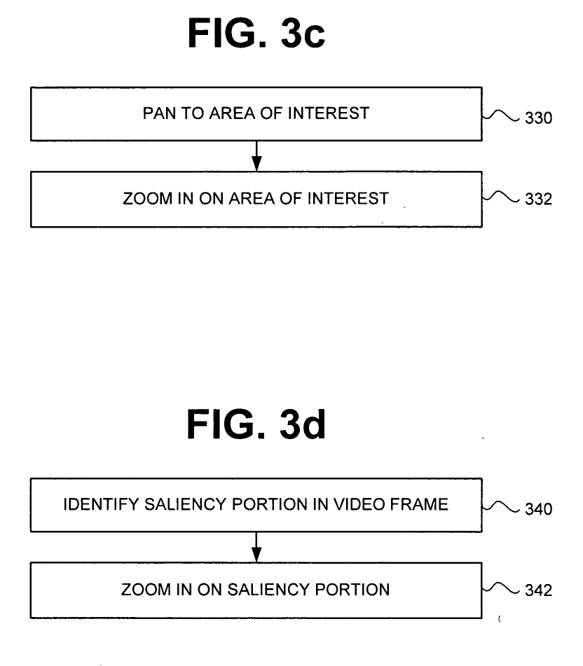

FIGS. 4a-4b illustrate different methods of enlarging the area of interest. Referring to FIG. 4a, which illustrates the first method. At block 410, an entire video frame is decoded from the bit stream, and the video frame is upscaled. Only the area of interest in the upscaled video frame is retained. At block 412, the rest of the upscaled video frame is cropped out. The upscaled area constitutes a video frame worth of data.

The upscaling is not limited to any particular method. Upscaling methods include, without limitation, bilinear interpolation and bicubic interpolation. Another method known as resolution synthesis is disclosed in U.S. Pat. No. 6,466,702. See also a paper by A. Youseff entitled “Analysis and comparison of various image downsampling and upsampling methods” Data Compression Conference, 1998. DCC '98. Proceeding 30 Mar.-1 Apr. 1998, page 1.

Reference is made to FIG. 4b, which illustrates a second method of enlarging an area of interest. This method is performed on a bit stream encoded in a scalable format. The playback device 14 decodes and buffers only that portion of the video frame corresponding to the area of interest (block 420), and upscales the buffered portion (block 422). Different video formats have different capabilities of finding a location in a bitstream. After a video frame is decoded, one can extract data for the right location based on geometric coordinates. Some scalable video coding method can support cropping without fully decoding.

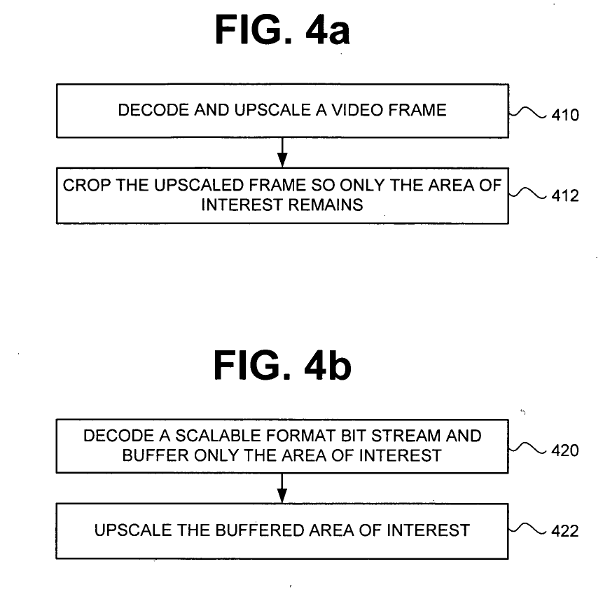

Reference is now made to FIG. 5, which illustrates an exemplary remote control unit 510. The remote control unit 510 includes a housing 512 and a motion sensor 514 for detecting motion of the housing 512. The motion sensor 514 may include gyroscopes as described in U.S. Pat. Nos. 5,898,421; 5,825,350; and 5,440,326.

The remote control unit 510 further includes a user interface (Ul) 516, which may include buttons for zooming in and out. For example, the remote control unit 510 can continually increase scale factor as long as a “zoom-in” button is depressed. The user interface 516 may also include buttons for presets for specific magnifications (e.g., +50%, +100%) and specific locations (e.g., center, upper right quandrant) in the video. The user interface 516 may include a numerical pad for entering the magnification, etc.

The remote control unit 510 may also include an orientation sensor 518 such as a compass. The compass indicates a direction of movement (whereas the motion sensor might only provide an absolute distance).

The remote control unit 510 further includes a processor 520 for generating commands in response to the user interface 516 and the motion and orientation sensors 514 and 518. The commands may include absolute position, motion vectors and scale factors. The commands are sent to a transmitter (e.g., IR, Bluetooth) 522, which transmits the command to the playback device.

A remote control unit according to the present invention is not limited to a motion sensor. Arrow buttons in the user interface, instead of the motion sensor, could be used to specify motion for panning across a scene.

A system according to the present invention is not limited to a remote control unit. A playback device such as a media center computer might include a mouse and keyboard. The area enlargement feature could be called by pressing keys on the keyboard, using the mouse to navigate a graphical user interface, etc.

Although specific embodiments of the present invention have been described and illustrated, the present invention is not limited to the specific forms or arrangements of parts so described and illustrated. Instead, the present invention is construed according to the following claims.

1. A method of interactively displaying video, the method comprising outputting the video for playback at full resolution, receiving an externally-generated command to enlarge an area of the video while the video is being played at full resolution, upscaling the area, and outputting the upscaled area for playback.

2. The method of claim 1, wherein the video is high definition video.

3. The method of claim 1, wherein the area in a first video frame is upscaled, and wherein the same spatial location in subsequent video frames is upscaled.

4. The method of claim 1, further comprising identifying the area.

5. The method of claim 4, wherein identifying the area includes starting at a default location and panning across the video to the area.

6. The method of claim 5, wherein the upscaling is performed after the panning.

7. The method of claim 5, wherein the upscaling is performed during the panning.

8. The method of claim 4, wherein identifying the area includes analyzing the frame to identify a saliency part of a scene.

9. The method of claim 1, wherein enlarging the area includes upscaling the area about a preset location.

10. The method of claim 1, wherein the video is provided as a bit stream, wherein the bit stream is decoded to produce a video frame, wherein the video frame is upscaled, and wherein the upscaled frame is cropped to the area of interest.

11. The method of claim 1, wherein the video is provided as a bit stream encoded in a scalable format, and wherein only the bit stream corresponding to the area is decoded and upscaled.

12. The method of claim 1, wherein a remote control is used to generate the command.

13. A video system comprising:
first means for decoding a video bit stream; and
second means for playing back a video at full resolution when normal viewing mode is selected and for enlarging an area of interest in response to externally-generated commands, the commands allowing the second means to identify and upscale an area of interest in the video while the video is being played, the second means outputting the upscaled area for playback.

14. A video system comprising:
a playback device having first and second modes of operation, the playback device playing a video at full resolution during the first mode, the second mode entered in response to externally-generated commands, the commands causing the playback device to identify and upscale an area of interest in the video and output the upscaled area for playback.

15. The system of claim 14, wherein the playback device upscales the area of interest in a first video frame and then upscales the same spatial location in subsequent video frames.

16. The system of claim 14, wherein identifying the area of interest includes starting at a default location and panning across the video to the area.

17. The system of claim 16, wherein the playback device performs the upscaling after the panning.

18. The system of claim 16, wherein the playback device performs the upscaling before the panning.

19. The system of claim 14, wherein identifying the area of interest includes analyzing the frame to identify a saliency part of a scene.

20. The system of claim 14, wherein upscaling the area of interest includes upscaling the area about a preset location.

21. The system of claim 14, wherein the video is provided as a bit stream, wherein the bit stream is decoded to produce a video frame, wherein the video frame is upscaled, and wherein the upscaled frame is cropped to the area of interest.

22. The system of claim 14, wherein the video is provided as a bit stream encoded in a scalable format, and wherein only the bit stream corresponding to the area is decoded and upscaled.

23. The system of claim 14, further comprising a remote control unit for generating the commands for enlarging the area of interest in the video.

24. A video remote control unit for causing the area of a video to be enlarged, the unit comprising a housing, means for detecting motion of the housing, means for generating a zoom command, and means, responsive to detected motion and direction, for generating pan commands.
